(19) United States
(12) Patent Application Publication
(10) Pub. No.: US 2013/0327055 A1
(43) Pub. Date: Dec. 12, 2013

(54) TRANSITION PIECE FOR A GAS TURBOMACHINE

(71) Applicant: Biju Nanukuttan, Bangalore (IN)

(72) Inventor: Biju Nanukuttan, Bangalore (IN)

(73) Assignee: GENERAL ELECTRIC COMPANY, Schenectady, NY (US)

(21) Appl. No.: 13/489,776

(22) Filed: Jun. 6, 2012

(51) Int. Cl. F02C 7/141; F02C 7/18

(52) U.S. Cl. 60/782; 415/116; 60/785

(57) ABSTRACT

A transition piece for a gas turbomachine includes a body having an outer surface and an inner surface that defines a flow duct, a plurality of openings that extend through the body, and an active control element provided at one or more of the plurality of openings. The active control element is configured and disposed to selectively establish a dimension of the one or more of the plurality of openings.

### BACKGROUND OF THE INVENTION

The subject matter disclosed herein relates to the art of turbomachines and, more particularly, to a transition piece for a gas turbomachine.

In a turbomachine, air is passed into an inlet of a compressor. The air is passed through various stages of the compressor to form a compressed airflow. A portion of the compressed airflow is passed to a combustion assembly and another portion of the compressed airflow is passed to a turbine portion and used for cooling. In the combustion assembly, the compressed airflow is mixed with fuel and combusted to form a high temperature gas stream and exhaust gases. The high temperature gas stream is channeled to the turbine portion via a transition piece. The transition piece guides the high temperature gas stream toward a hot gas path of the turbine portion. The high temperature gas stream expands through various stages of the turbine portion converting thermal energy to mechanical energy that rotates a turbine shaft. The turbine portion may be used in a variety of applications including providing power to a pump, an electrical generator, a vehicle, or the like.

### BRIEF DESCRIPTION OF THE INVENTION

According to one aspect of the exemplary embodiment, a transition piece for a gas turbomachine includes a body having an outer surface and an inner surface that defines a flow duct. A plurality of openings extend through the body, and an active control element provided at one or more of the plurality of openings. The active control element being configured and disposed to selectively establish a dimension of the one or more of the plurality of openings.

According to another aspect of the exemplary embodiment, a turbomachine includes a compressor portion, a turbine portion, and a combustor assembly fluidically connected to the compressor portion and the turbine portion. A transition piece links the combustor assembly and the turbine portion. The transition piece includes a body having an outer surface and an inner surface that defines a flow duct, a plurality of openings extend through the body, and an active control element provided at one or more of the plurality of openings. The active control element is configured and disposed to selectively establish a dimension of the one or more of the plurality of openings.

According to yet another aspect of the exemplary embodiment, a method of operating a turbomachine includes combusting fuel and air in a combustion chamber to form combustion gases, guiding the combustion gases through a transition piece into a turbine portion of a turbomachine, directing compressor air over an outer surface of the transition piece, passing the compressor air through one or more dilution openings formed in the transition piece to mix with the combustion gases, and signaling an active control element associated with at least one of the one or more of the dilution openings to control a flow rate of the compressor air.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a turbomachine having a transition piece in accordance with an exemplary embodiment;

FIG. 2 is a partial cross-sectional view of a combustor assembly and transition piece of the turbomachine of FIG. 1;

FIG. 3 is a perspective view of the transition piece of FIG. 2;

FIG. 4 is a plan view of a fluid injector having an active control element in accordance with an exemplary embodiment;

FIG. 5 is a block diagram illustrating a controller coupled to the active control element of FIG. 4; and

FIG. 6 is a flow chart illustrating a method of controlling the active control element of FIG. 4.

The detailed description explains embodiments of the invention, together with advantages and features, by way of example with reference to the drawings.

### DETAILED DESCRIPTION OF THE INVENTION

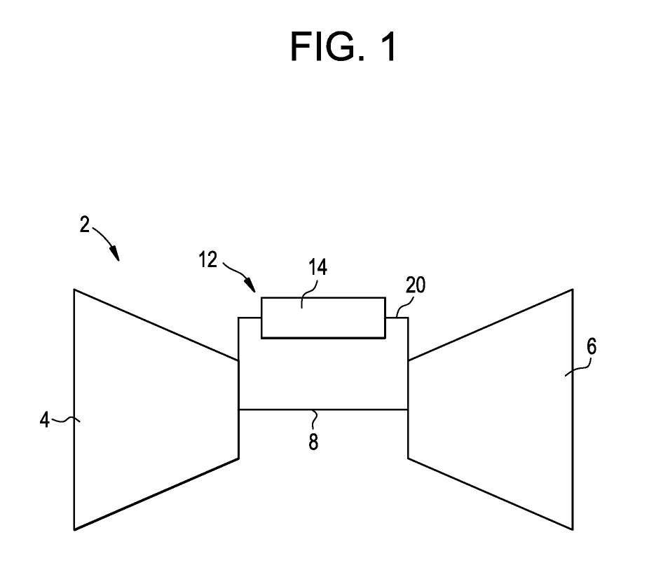

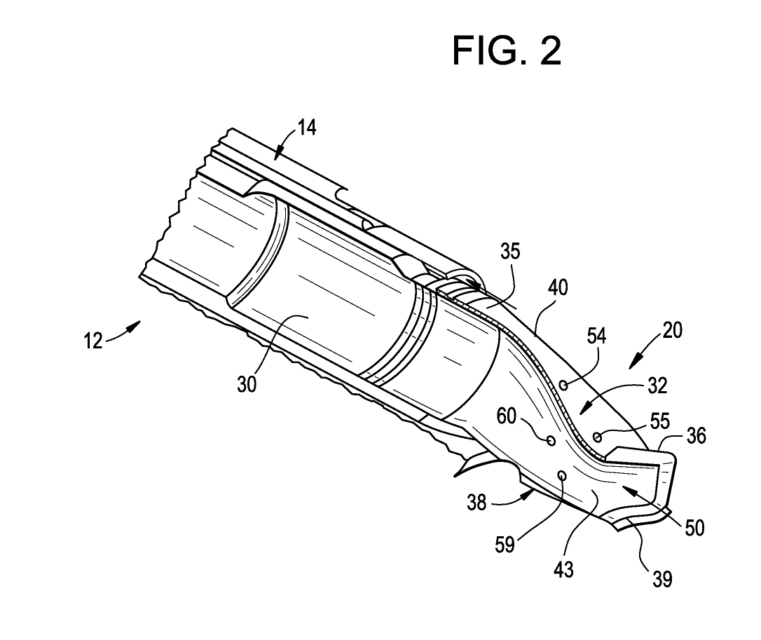

With reference to FIGS. 1 and 2, a turbomachine in accordance with an exemplary embodiment is indicated generally at 2. Turbomachine 2 includes a compressor portion 4 operatively connected to a turbine portion 6 through a common compressor/turbine shaft 8. Compressor portion 4 is also fluidly connected to turbine portion 6 through a combustor assembly 12. Combustor assembly 12 includes one or more circumferentially spaced combustors 14 arranged in a can-annular array. Of course it should be understood that combustor assembly 12 may also include other combustor arrangements. Combustor 14 is fluidly connected to turbine portion 6 through a transition piece 20. With this arrangement air from compressor portion 4 is mixed with fuel to form a combustible mixture. The combustible mixture is combusted within a combustion chamber 30 of combustor 14 forming hot gases. The hot gases flow from combustor 14 to a first stage (not shown) of turbine portion 6.

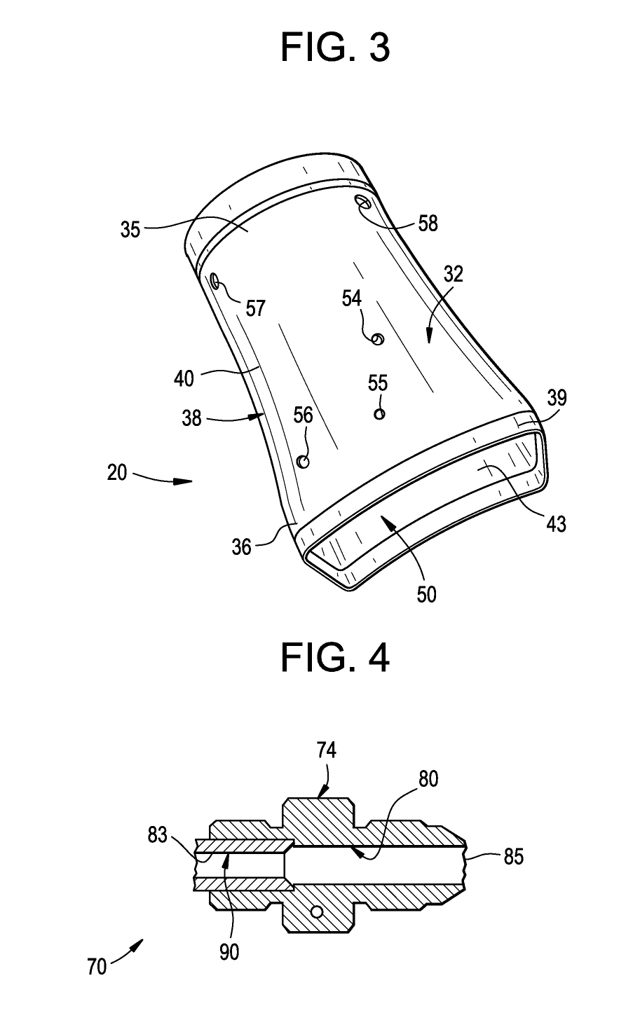

Transition piece 20 includes a body 32 having a first end 35 that extends to a second end 36 through an intermediate portion 38. First end 35 is coupled to combustor 14 while second end 36 connects with turbine portion 6 through a frame element 39. Intermediate portion 38 includes an outer surface 40 and an inner surface 43. Inner surface 43 defines a flow duct 50 that extends between first and second ends 35 and 36. Transition piece 20 includes a plurality of dilution openings 54-60 (FIGS. 2 and 3) formed in intermediate portion 38. Dilution openings 54-60 extend through body 32 to fluidly connect flow duct 50 with an external flow area (not separately labeled). Each dilution opening 54-60 includes a dimension, for example a diameter, which is selectively adjusted to control fluid flow passing into flow duct 50. More specifically, compressed air from compressor portion 4 flowing over outer surface 40 may pass through dilution openings 54-60 into flow duct 50 to mix with the hot gases from combustor 14. The addition of the compressed air conditions the hot gas to achieve a desired temperature profile as will be detailed more fully below. The desired temperature profile is selected to enhance an over all operational life of turbine blades while, at the same time, maintaining turbomachine efficiency.

In accordance with one aspect of the exemplary embodiment, transition piece 20 is provided with a plurality of fluid injectors 70 such as shown in FIG. 4, that selectively control the dimension of respective ones of dilution openings 54-60. Fluid injector 70 includes a body 74 having a central passage 80. Central passage 80 includes an inlet 83 and an outlet 85. Inlet 83 is exposed to compressed air flowing over outer surface 40 and outlet 85 is arranged within flow duct 50. Central passage 80 is provided with an active control element 90 that is selectively controlled to adjust a flow rate of compressed air passing through respective ones of dilution openings 54-60.

In accordance with one aspect of the exemplary embodiment, active control element 90 takes the form of a shaped memory alloy (SMA) actuator. Shaped memory alloys change shape when exposed to heat or when actively heated, and return to an original shape as the heat is removed. In accordance with yet another aspect of the exemplary embodiment, active control element 90 takes the form of a micro-electro-mechanical actuator that employs a micro electro-mechanical systems (MEMS) element to control fluid flow passing through central passage 80. In accordance with still another aspect of the exemplary embodiment, active control element 90 takes the form of a micro optical-mechanical (MOM) or a micro optical-electro-mechanical (MOEM) actuator that is controlled by light through, for example fiber optic cables. In accordance with still another aspect of the exemplary embodiment, active control element 90 takes the form of a piezoelectric actuator.

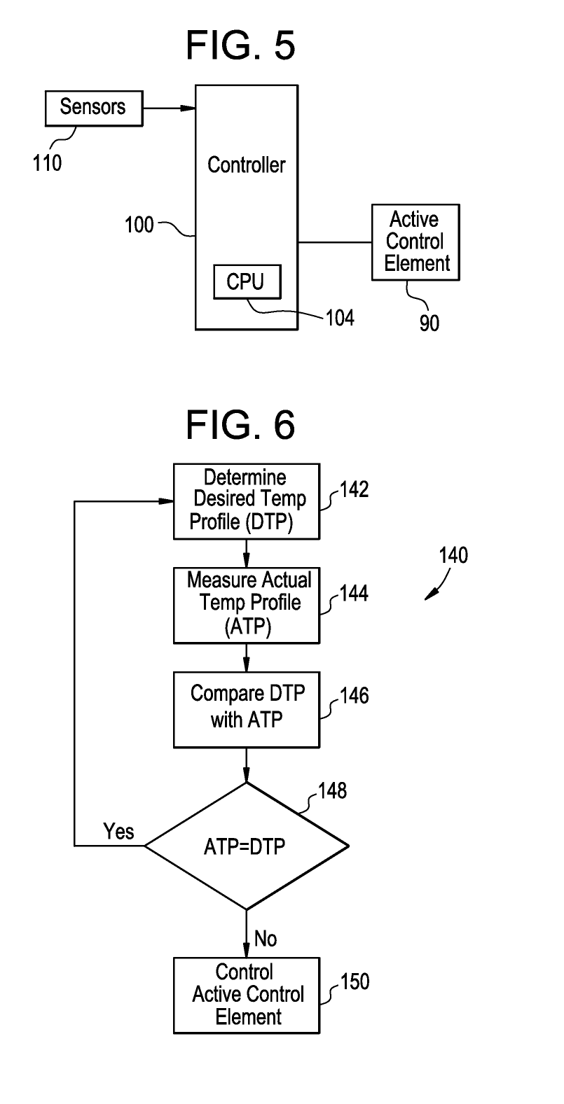

In accordance with another aspect of the exemplary embodiment, active control element 90 is operatively coupled to a controller 100 as shown in FIG. 5. Controller 100 includes a central processing unit (CPU) 104 and is also coupled to one or more sensors 110 provided in various portions of turbomachine 2. Sensors 110 include one or more of a micro-electro-mechanical system (MEMS) sensor, a piezoelectric sensor, a transducer, and the like. Sensors 110 provide input to controller 100 of one or more operating parameters of turbomachine 2. The one or more operating parameters include a temperature profile of the hot or combustion gases flowing through flow duct 50. Controller 100 determines a desired temperature profile for the hot gases and, if conditioning is warranted, signals active control element 90 to establish a desired flow rate of compressor gases into flow duct 50.

A method of operating turbomachine 2 and, more specifically, controlling a temperature profile of gases flowing through flow duct 50 is indicated at 140 in FIG. 6. Controller 100 determines a desired temperature profile (DTP) of combustion gases flowing through flow duct 50 as shown in block 142. Controller 100 employs inputs from sensors 110 and a stored algorithm to select the DTP. Controller 100 also measures an actual temperature profile (ATP) of the gases flowing through flow duct 50 as shown in block 144. Controller 100 compares the DTP with the ATP in block 146. If the DTP is the same as or within a desired range, for example 5% of the ATP, no action is taken as seen on block 148. If, however it is determined in block 148 that the DTP does not equal or fall within the desired range of the ATP, controller 100 signals active control element 90 to adjust the dimension of central passage 80 to control an amount of compressor air entering into flow duct 50 to mix with and condition the hot gases from combustor 14 to achieve the DTP as seen in block 150. Adjusting the dimension of central passage 80 includes increasing the dimension of central passage 80 to increase compressor air into flow duct 50 and decreasing the dimension of central passage 80 to reduce the amount of compressor air passing into flow duct 50.

At this point it should be understood that the exemplary embodiments provide a system and method for controlling fluid flow into a transition piece to condition gases flowing from a combustor to a turbine portion of a turbomachine. It should be understood that while shown and described as being formed as part of a fluid injector, the active control element can be mounted directly into one or more of the dilution openings. Also, it should be appreciated that while various examples of active control elements and sensors were described and claimed in connection with the exemplary embodiment, other types of active control elements and sensors may also be employed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A transition piece for a gas turbomachine comprising:
a body having an outer surface and an inner surface that defines a flow duct;
a plurality of openings extending through the body; and
an active control element provided at one or more of the plurality of openings, the active control element being configured and disposed to selectively establishing a dimension of the one or more of the plurality of openings.

2. The transition piece according to claim 1, further comprising: a fluid injector positioned in the one or more of the plurality of openings, the active control element being provided in the fluid injector.

3. The transition piece according to claim 1, further comprising: a controller operatively connected to the active control element, the controller being configured and disposed to adjust the active control element to establish a desired dimension of the one or more of the plurality of openings.

4. The transition piece according to claim 3, further comprising: one or more sensors operatively connected to the controller, the controller being configured and disposed to establish the desired dimension of the one or more of the plurality of openings based on an operating parameter sensed by the one or more sensors.

5. The transition piece according to claim 4, wherein the one or more sensors comprises a micro-electro-mechanical system (MEMS) sensor.

6. The transition piece according to claim 4, wherein the one or more sensors comprises a piezoelectric sensor.

7. The transition piece according to claim 1, wherein the active control element comprises a shaped memory alloy actuator.

8. The transition piece according to claim 1, wherein the active control element comprises a micro-electro-mechanical system (MEMS) actuator.

9. The transition piece according to claim 1, wherein the active control element comprises one of a micro-optical mechanical system (MOMS) and a micro-optical electro-mechanical system (MOEMS) actuator.

10. The transition piece according to claim 1, wherein the active control element comprises a piezoelectric actuator.

11. A turbomachine comprising:
a compressor portion;
a turbine portion;
a combustor assembly fluidically connected to the compressor portion and the turbine portion; and
a transition piece linking the combustor assembly and the turbine portion, the transition piece comprising:
a body having an outer surface and an inner surface that defines a flow duct;
a plurality of openings extending through the body; and
an active control element provided at one or more of the plurality of openings, the active control element being configured and disposed to selectively establish a dimension of the one or more of the plurality of openings.

12. The turbomachine according to claim 11, further comprising: a fluid injector positioned in the one or more of the plurality of openings, the active control element being provided in the fluid injector.

13. The turbomachine according to claim 11, further comprising: a controller operatively connected to the active control element, the controller being configured and disposed to adjust the active control element to establish a desired dimension of the one or more of the plurality of openings.

14. The turbomachine according to claim 13, further comprising: one or more sensors operatively connected to the controller, the controller being configured and disposed to establish the desired dimension of the one or more of the plurality of openings based on an operating parameter sensed by the one or more sensors.

15. The turbomachine according to claim 11, wherein the active control element comprises one of a shaped memory alloy actuator, a micro-electro-mechanical system (MEMS) actuator, a micro-optical mechanical system (MOMS) actuator, a micro-optical electro-mechanical system (MOEMS) actuator, and a piezoelectric actuator.

16. A method of operating a turbomachine comprising:
combusting fuel and air in a combustion chamber to form combustion gases;
guiding the combustion gases through a transition piece into a turbine portion of a turbomachine;
directing compressor air over an outer surface of the transition piece;
passing the compressor air through one or more dilution openings formed in the transition piece to mix with the combustion gases; and
signaling an active control element associated with at least one of the one or more dilution openings to control a flow rate of the compressor air.

17. The method of claim 16, further comprising: sensing an operating parameter of the turbomachine; and
signaling the active control element to control the flow rate of the compressor air based on the operating parameter of the turbomachine.

18. The method of claim 17, further comprising: controlling the flow rate of the compressor air to adjust a temperature profile of the combustion gases.

19. The method of claim 16, wherein signaling the active control element comprises adjusting a dimension of the one or more dilution openings.

20. The method of claim 19, wherein adjusting a dimension of the one or more dilution openings comprises actuating one of a one of a shaped memory alloy actuator, a micro-electro-mechanical system (MEMS) actuator, a micro-optical mechanical system (MOMS) actuator, a micro-optical electro-mechanical system (MOEMS) actuator, and a piezoelectric actuator.
